(19) United States
(12) Patent Application Publication
(10) Pub. No.: US 2023/0313719 A1
(43) Pub. Date: Oct. 5, 2023

(54) SMALL AIR-COOLED ENGINE WITH CATALYTIC CONVERTER WITH RUTHENIUM CATALYST

(71) Applicant: BRIGGS & STRATTON, LLC, Wauwatosa, WI (US)

(72) Inventors: Jacob Zuehl, Hartford, WI (US); Michael D. Pitcel, Waukesha, WI (US)

(73) Assignee: BRIGGS & STRATTON, LLC, Wauwatosa, WI (US)

(21) Appl. No.: 17/925,979

(22) PCT Filed: May 21, 2021
(86) PCT No.: PCT/IB2021/054446

§ 371 Date: Nov. 17, 2022

Related U.S. Application Data
(60) Provisional application No. 63/028,635, filed on May 22, 2020.

(51) Int. Cl. F01N 3/10; F01P 1/02; F01P 1/06; F01P 5/04; B01J 23/46; B01J 23/42

(52) U.S. Cl. CPC F01N 3/10; F01P 1/02; F01P 1/06; F01P 5/04; B01J 23/462; B01J 23/42; B01J 23/468; F01N 2370/02; F01N 2590/06; F01P 2001/023

(57) ABSTRACT

A small-air cooled internal combustion engine includes an engine block including a cylinder, a piston within the cylinder, a crankshaft configured to be driven by the piston, a blower system including a fan that is configured to pull air over the engine block, a fuel system for supplying an air-fuel mixture to the cylinder, and an exhaust system for removing exhaust from the cylinder. The exhaust system comprises an exhaust inlet, a muffler and, a catalytic converter including a catalyst. The catalyst comprises a precious metal loading having ruthenium as a primary element by mass.

### CROSS-REFERENCE TO RELATED APPLICATION

This application claims priority to U.S. Provisional Patent Application No. 63/028,635, filed May 22, 2020, the content of which is hereby incorporated by reference in its entirety.

### BACKGROUND

The present application relates generally to the field of small air-cooled internal combustion engines. More specifically, the present application relates to catalytic converters for small air-cooled internal combustion engines.

### SUMMARY

At least one embodiment relates to a small air-cooled internal combustion engine including an engine block including a cylinder, a piston within the cylinder, a crankshaft configured to be driven by the piston, a blower system including a fan, the fan configured to pull air over the engine block, a fuel system for supplying an air-fuel mixture to the cylinder, and an exhaust system for removing exhaust from the cylinder. The exhaust system comprises an exhaust inlet and a catalytic converter including a catalyst. The catalyst has a precious metal loading having ruthenium as a primary element by mass.

Another embodiment relates to a small air-cooled internal combustion engine. The small air-cooled engine includes an engine block including at least two cylinders. The engine displacement is 1000 cubic centimeters or less. A piston is received within each of the cylinders. A crankshaft is configured to be driven by the pistons. The engine further includes a blower system that includes a fan. The fan is configured to direct air over the engine block. An air-fuel mixing device for supplying an air-fuel mixture to each of the cylinders for combustion is included as well. The engine further includes an exhaust system for removing exhaust from each of the cylinders. The exhaust system includes exhaust ports formed in each of the cylinders to allow and direct exhaust to exit each of the cylinders following combustion. The exhaust system further includes a catalytic converter that includes a catalyst. The catalytic converter is configured to receive the exhaust from each of the cylinders and direct the exhaust over the catalyst. The catalyst comprises a precious metal loading of at least 40% ruthenium by mass.

Another embodiment relates to a catalytic converter for a small air-cooled internal combustion engine having a displacement of one thousand cubic centimeters or less. The catalytic converter includes an inlet, a chamber, and an outlet. The chamber is fluidly coupled with the inlet and supports a substrate having a catalyst disposed thereon. The catalyst includes a precious metal loading having ruthenium as a primary element by mass. The outlet is fluidly coupled with the chamber and is configured to direct gas outwardly away from the chamber.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view from above of a small air-cooled internal combustion engine according to an exemplary embodiment.

FIG. 2 is a perspective view from below of the small air-cooled internal combustion engine of FIG. 1.

FIG. 3 is a schematic diagram of a single cylinder small air-cooled internal combustion engine according to an exemplary embodiment.

FIG. 4 is a schematic diagram of a two cylinder small air-cooled internal combustion engine according to an exemplary embodiment.

FIG. 5 is a cross-sectional view of a catalytic converter of the small air-cooled internal combustion engine of FIG. 1.

FIG. 6 is a graph of the concentration of nitrogen oxide and hydrocarbons at the inlet and the outlet of a three-way catalytic converter over a series of measurement points.

FIG. 7 is a graph of the concentration of nitrogen oxide and hydrocarbons at the inlet and the outlet of a ruthenium based catalytic converter over a series of measurement points.

FIG. 8 is a graph of the concentration of ammonia at the inlet and the outlet of a three-way catalytic converter over a series of measurement points.

FIG. 9 is a graph of the concentration of ammonia at the inlet and the outlet of a ruthenium based catalytic converter over a series of measurement points.

FIG. 10 is a graph of conversion efficiency for different pollutants using a ruthenium based catalyst at various air-to-fuel ratios.

FIG. 11 is a graph comparing total emissions of a small engine with and without the ruthenium based catalytic converter of FIG. 5.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Referring to the figures generally, the engines described herein may be used in outdoor power equipment, standby generators, portable jobsite equipment, or other appropriate uses. Outdoor power equipment includes lawn mowers, riding tractors, snow throwers, pressure washers, portable generators, tillers, log splitters, zero-turn radius mowers, walk-behind mowers, wide-area walk-behind mowers, riding mowers, standing mowers, industrial vehicles such as forklifts, utility vehicles, etc. Outdoor power equipment may, for example, use an internal combustion engine to drive an implement, such as a rotary blade of a lawn mower, a pump of a pressure washer, an auger of a snow thrower, the alternator of a generator, and/or a drivetrain of the outdoor power equipment. Portable jobsite equipment includes portable light towers, mobile industrial heaters, and portable light stands.

Generally speaking, a small engine is an engine having an engine displacement of 1,000 cubic centimeters or less and a power rating of 40 horsepower (˜30 kilowatts) or less. Engine displacement is the combined swept volume of the pistons inside the cylinders of an engine and is calculated by the bore (diameter of the cylinders), stroke (distance of piston travel), and number of cylinders of an engine.

Typically, a small engine includes a cooling system. Common cooling system configurations for small engines include air cooling, liquid cooling, and oil cooling. An air cooling system generally includes a blower system having a blower housing and a fan within the blower housing. Each of the cylinders of the engine include fins, which increase the surface area of the cylinders to maximize the heat transfer from the cylinder to the surrounding air. A fan blows the air surrounding the cylinders and removes the heat from the engine.

A liquid cooling system (e.g. a water cooled engine) includes a radiator fluidly coupled to a jacket through a conduit. The jacket at least partially surrounds each of the cylinders of the engine. A pump circulates a liquid (e.g. coolant, water, etc.) through the radiator and the jacket. The pump moves the liquid out of the radiator at a radiator outlet, through the conduit, and into the jacket. The cylinders dissipate heat through the jacket and into the liquid, causing the engine to cool and the liquid to warm. The warm liquid then flows out of the jacket, through a conduit, and into the radiator at a radiator inlet. Air flows over the radiator, cooling the liquid. The liquid cooling system may further include a fan configured to blow air over the radiator. The pump then continues to circulate the cooled liquid out of the radiator and into the jacket.

An oil cooling system includes an oil cooler (e.g. a radiator) in line of a standard oil circulation system. In an oil cooling system, the oil in the engine is used for both lubrication and engine cooling. The oil flows through each of the cylinders of the engine, and the cylinders dissipate heat into the oil, causing the oil to warm. The warm oil flows into an oil cooler, and air flows over the oil cooler cooling the oil. The cool oil then flows back into the standard oil circulation system.

Small engines may also use a combination of cooling systems. For example, some small engines use a combination of air cooling and oil cooling. Some engines, for example some motorcycle engines, use air cooling as the primary way to cool the engine. While the motorcycle is consistently moving, air continuously flows over the engine, and the air cooling system is sufficient to keep the engine cool. If the motorcycle cannot move consistently (e.g. a motorcycle being driven in traffic), an oil cooling system can be used to supplement the air cooling system and prevent the engine from overheating when the air cooling system is unable to sufficiently cool the engine.

As described herein, an air-cooled engine is an engine that is cooled using an air cooling system, either on its own or in a combination of an air cooling system and an oil cooling system.

Different government regulatory bodies have emissions standards for small engines. Federal agencies, such as the Environmental Protection Agency (EPA) have emission standards for small engines, limiting the hydrocarbon (HC) and nitrogen oxides (NOₓ) amounts that an engine can emit into the environment. Other regulatory bodies also set forth emissions standards. California, which has one of the largest state populations in the United States of America, sets its own regulations, which have often been stricter than those set forth by the EPA. The California Air Resource Board (“CARB”) provides regulations for small off-road engines, which it defines as spark-ignition engines rated at or below 19 kilowatts (25.4794 horse power) (“SORE”). Often, small engines are able to meet the applicable emissions standards without the use of catalytic converters. Larger engines (e.g., automotive engines) are similarly regulated by government regulatory bodies, and have emissions standards. Larger engines typically have a higher standard of reducing emissions by 99%. To meet these emission requirements, catalytic converters are typically used in larger engines and are included in the exhaust system of an engine to reduce toxic gases and pollutants (e.g. hydrocarbons and nitrogen oxides) produced by combustion and found within the exhaust of the engine.

The use of a catalytic converter on a small engine may reduce certain emissions. If used, for example, a catalytic converter may reduce the emissions of a small engine by 70-90%. It would be advantageous for engine manufacturers to use a catalytic converter that is cost-effective to manufacture and can be installed in the exhaust system of existing small engine models with no or limited redesign of those engine models to enable manufacturing of the updated engines with catalytic converters.

Typically, a catalytic converter includes a substrate and a catalyst. The substrate creates a structure (e.g., a honeycomb structure) having an increased surface area compared to the cross section of the catalytic converter. The substrate is typically constructed from a ceramic or metal material. The catalyst is then disposed onto the substrate. A catalytic converter may further include a washcoat to further increase the surface area of the catalytic converter. The washcoat is made from a material (e.g. aluminum oxide, titanium oxide, silicon dioxide, a silica and/or alumina mixture, etc.) that can form a rough coating on the substrate. The catalyst is suspended in the washcoat, and then the mixture is applied to the substrate. An engine produces exhaust gases (e.g., nitrogen oxides (NOₓ), carbon monoxide (CO), hydrocarbons (HC)) during combustion. The exhaust gases flow through the catalytic converter, and react with the catalyst (e.g., oxidation and reduction reactions). The reaction with the catalyst catalyzes the exhaust gases so that the catalytic converter emits products that are less harmful to the environment (e.g., nitrogen (N₂), carbon dioxide (CO₂), water (H₂O)). A three way catalytic converter (TWC) has three simultaneous reactions occurring. A TWC reduces nitrogen oxides (NOₓ) to nitrogen (N₂), oxidizes carbon monoxide (CO) to carbon dioxide (CO₂), and oxidizes unburnt hydrocarbons (HC) to carbon dioxide (CO₂) and water (H₂O). Precious metals, such as platinum, palladium, iridium, and rhodium are typical catalysts used in a catalytic converter. Platinum, palladium, iridium, and rhodium each actively react with exhaust gases and produce a cleaner exhaust. Platinum, palladium, iridium, and rhodium also remain stable in a variety of engine operation conditions (e.g. rich and lean conditions). Other metals, such as cerium, iron, manganese, nickel, and copper can also be used as a catalyst. Some catalytic converters use combinations of different metals. Precious metals are expensive, and can account for a large portion of the cost of a catalytic converter. The precious metals often accounts for 30-50% of the total cost of the materials of a catalytic converter. As small engine emission regulation becomes stricter, it would be beneficial to have a catalytic converter suited for use in small engines, and using low cost materials.

Referring to the FIGURES generally, described herein is a catalytic converter including a ruthenium-based, or primarily-ruthenium, catalyst. Ruthenium is a less expensive alternative to commonly used catalyst materials such as platinum, palladium, iridium, and rhodium, which are often used in a three-way catalyst. The cost of ruthenium can be ½ of the cost of platinum, 1/7 of the cost of palladium, 1/10 the cost of iridium, and 1/30 the cost of rhodium.

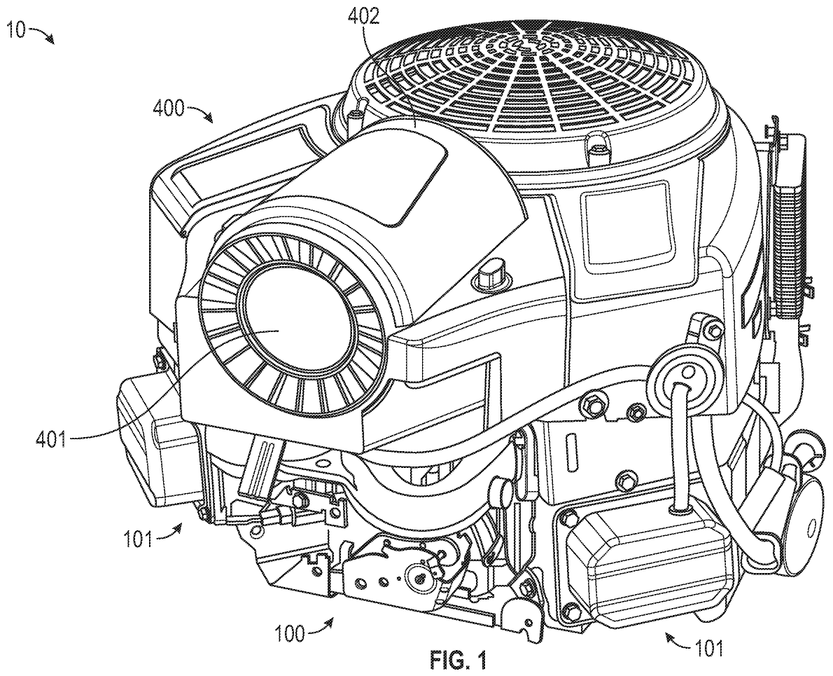

Referring to FIG. 1, a small air-cooled internal combustion engine 10, is shown. The engine 10 is, for example, a V-twin engine, and includes an engine block 100 having two cylinders 101 arranged in a V-twin configuration. In an exemplary embodiment, the engine 10 has an engine displacement of 810 cubic centimeters. The engine 10 further includes a blower system 400 including a fan 401 for each of the cylinders 101 and a blower housing 402 surrounding the blower system and the engine 1.

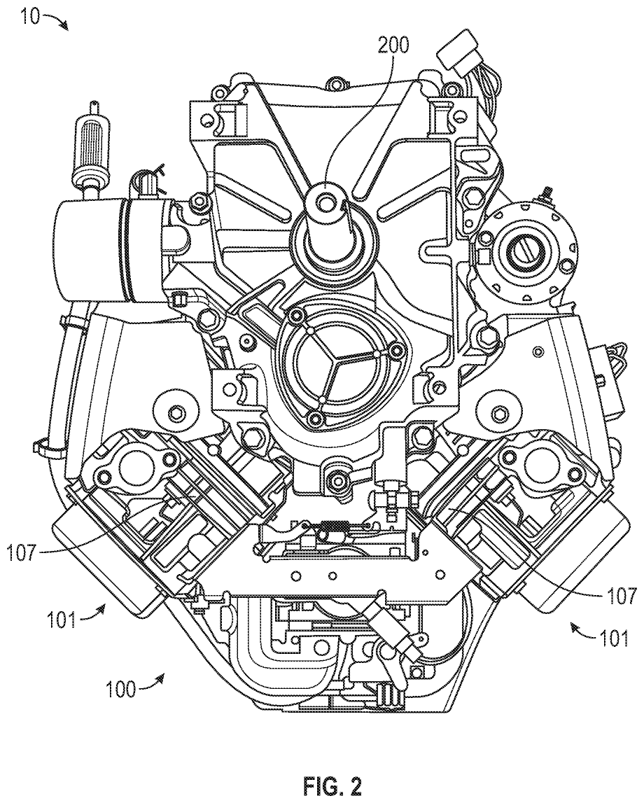

Referring to FIG. 2, a small air-cooled internal combustion engine 10 is shown. The engine 10 includes an engine block 100 having two cylinders 101. Pistons within the cylinders 101 reciprocate and drive a crankshaft 200. The cylinders 101 include heat fins 107. The heat fins 107 are configured to increase the rate of heat transfer between the cylinders 101 and the air surrounding the engine 10.

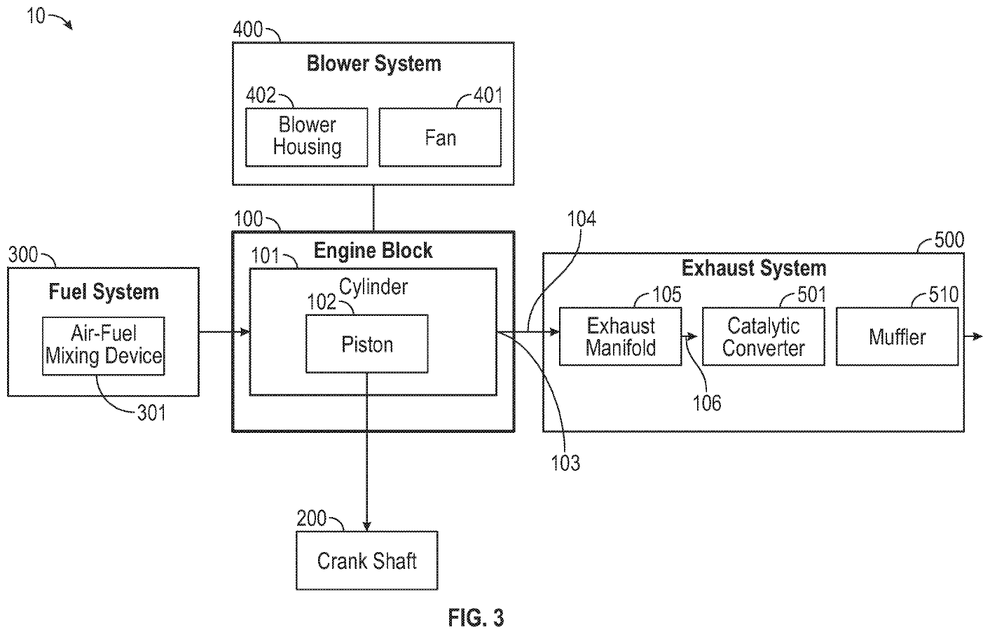

Referring to FIG. 3, a small air-cooled internal combustion engine 10 includes an engine block 100. The engine block 100 includes a cylinder 101 with a piston 102 disposed within the cylinder 101. The piston 102 is configured to reciprocate within the cylinder 101 and drive a crankshaft 200. In some embodiments, the engine block 100 includes multiple cylinders 101, each having a piston 102 (e.g., a two-cylinder engine arranged in a V-twin configuration).

A fuel system 300 includes an air-fuel mixing device 301 for suppling an air-fuel mixture to the cylinder 101. In some embodiments, the air-fuel mixing device 301 is a carburetor for mixing air and fuel to produce the air-fuel mixture. In some embodiments, the fuel system 300 is an electronic fuel system and the air-fuel mixing device 301 is an electronic fuel injector and a throttle body for mixing air and fuel to produce the air-fuel mixture. In some embodiments, the electronic fuel injector is positioned in the intake manifold of a cylinder. The stoichiometric air to fuel ratio for combustion of gasoline is 14.7. When an engine operates below the stoichiometric mixture (e.g., the ratio is less than 14.7, indicating more fuel is present than needed to perform a theoretically ideal combustion reaction), the engine is operating under rich conditions. The fuel systems of small engines (e.g., the engine 10) are often designed to provide a rich air to fuel ratio, as steady state operation of the system may remain below an air to fuel ratio of 14.7. While the engine may be designed to run under typically rich conditions, periods of operation may also include temporary lean operating conditions where the engine 10 runs at an air to fuel ratio greater than 14.7. Rich air to fuel ratios can be beneficial for thermal and combustion stability of a small engine, but can also result in increased emissions caused by unreacted or partially combusted gasoline. In contrast, larger engines and particularly automotive engines (which are also subject to emissions regulations from the EPA and CARB) are designed to run at the stoichiometric air to fuel ratio to help those engines meet their emissions standards.

A blower system 400 is configured to provide air to cool the engine 10. The blower system 400 includes a fan 401 and a blower housing 402. The fan 401 is configured to pull air from the environment surrounding the engine 10 during the operation of the engine 10. The blower housing directs the cooling air over the engine block to cool the engine 10, resulting in an air-cooled engine. This is in contrast to a liquid-cooled engine, for example an automotive engine with a radiator and liquid coolant circulation system for cooling the engine. In some embodiments the blower system 400 includes one or more fans 401. In some embodiments, the blower system 400 includes a fan 401 for each of the engine cylinders 101. In some embodiments, the fan 401 is an electric fan. In other embodiments, the fan 401 is driven by the engine 10.

The small air-cooled internal combustion engine 10 further includes an exhaust system 500 configured to direct exhaust produced by the engine 10 away from the small air-cooled internal combustion engine 10. Each cylinder 101 includes an exhaust port 103 through which exhaust from combustion exits the combustion chamber of the cylinder 101. From the exhaust port 103 the exhaust flows through an exhaust passage 104, through the exhaust manifold 105, and into the exhaust system 500 and to the muffler 510, if present. The muffler can include a resonator chamber or other sound attenuating structures to reduce the noise level produced by the engine. On single cylinder engines, the exhaust manifold 105 may include a single runner. On multiple cylinder engines, the exhaust passages 104 of the cylinders may be formed in the exhaust manifold 105 that connects the exhaust ports 103 of the cylinders 101 to the exhaust system 500 such that the exhaust flows from the each cylinder 101 is combined into a single exhaust flow 106 provided to the exhaust system 500. The catalytic converter 501 is positioned within the exhaust system 500 so that exhaust flows through the catalytic converter 501 to reduce the emissions of the exhaust that exits the engine 10 either through the muffler 510 or through an exhaust tube extending away from the engine 10. The catalytic converter 501 can be positioned upstream of the muffler 510, if present. The catalytic converter 501 includes a catalyst configured to react with the exhaust in an oxidation and reduction reaction and produce a cleaned exhaust. In some embodiments, the catalytic converter 501 is positioned in the exhaust passage 104 and upstream of the muffler 510 (if present) so that the exhaust is cleaned prior to entering the muffler 510 or prior to exiting the exhaust tube to the atmosphere. In some embodiments, the catalytic converter 501 is positioned to receive exhaust gases and can emit exhaust gases directly outward, into the environment (e.g., an not into a muffler). In some examples, the catalytic converter 501 includes an adaptor that is configured to couple with a removable muffler 510. In some embodiments, the catalytic converter 501 is positioned in the muffler 510 before or upstream of the resonator chamber or other sound attenuating structures. In some embodiments, the catalytic converter 501 is positioned in the resonator chamber or other sound attenuating structures. In still other embodiments, the catalytic converter 501 is positioned in the muffler 501 after or downstream of the resonator chamber or other sound attenuating structures. In some embodiments, the catalytic converter 501 is configured to retrofit onto an existing engine (e.g. engine 10), without the need to redesign the existing engine.

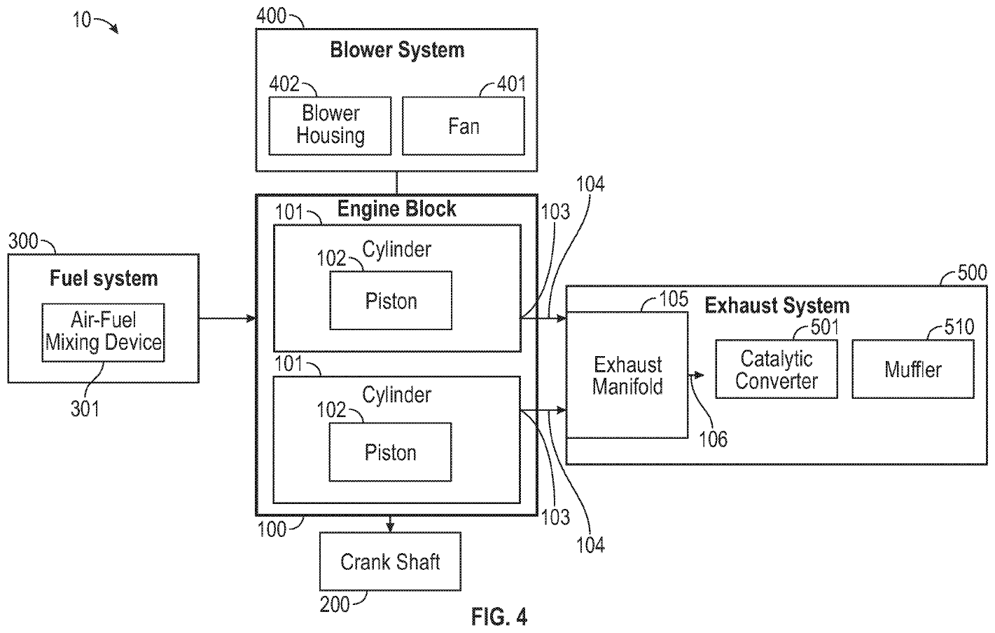

Referring to FIG. 4, an exemplary embodiment of a small air-cooled internal combustion engine 10 including two cylinders is illustrated. The engine 10 includes a pair of the cylinders 101, each cylinder 101 including a piston 102 and an exhaust port 103 for exhaust from combustion to exit the cylinder 101. The exhaust exits the cylinders 101 at the exhaust port 103 and flows through exhaust passages 104 into an exhaust manifold 105. The exhaust manifold 105 joins each of the exhaust passages 104 into a single exhaust passage 106. In some embodiments of multiple cylinder engines, a catalytic converter 501 is positioned in each exhaust passage 104 so that there is one catalytic converter used per cylinder of the engine. In other embodiments, a single catalytic converter 501 is positioned in the exhaust manifold 105 at a location after the exhaust passages 104 have joined into a single exit passage 106, such that the exhaust gasses are treated before providing the combined exhaust flow to the muffler 510, if present.

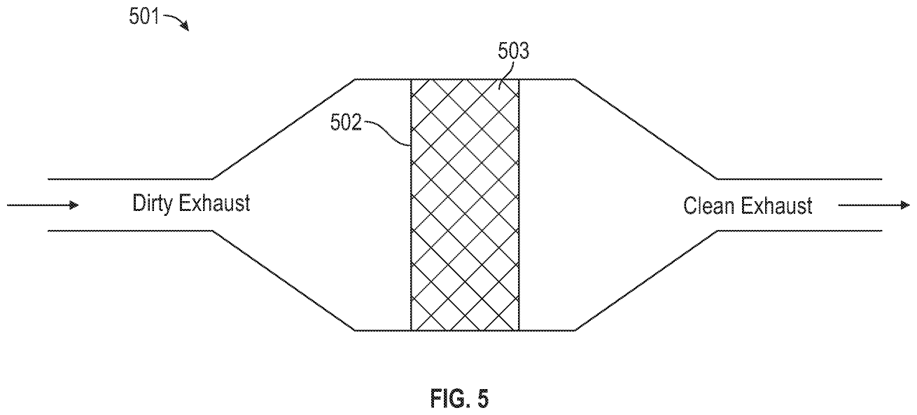

Referring to FIG. 5, the catalytic converter 501 includes a substrate 502 with a ruthenium precious metal 503 disposed on the substrate 502. The substrate 502 may be a ceramic or metallic monolith having a honeycomb structure (e.g. square, hexagonal, triangular, etc.) to increase the surface area of the substrate 502. The catalytic converter 501 may further include a washcoat disposed on the substrate 502, configured to create a rough surface and further increase the surface area of the substrate 502. Exhaust flows from the cylinder 101 into the exhaust system 500, and through the catalytic converter 501. The dirty exhaust flows through the substrate 502 and the ruthenium catalyst 503. As the dirty exhaust flows through the ruthenium catalyst 503, the exhaust undergoes reduction and oxidation reactions. The ruthenium catalyst 503 interacts with the dirty exhaust and catalyzes the reduction and oxidation reactions. The resulting exhaust flowing out from the catalyst 503 and substrate 502 is a clean exhaust. For example, the dirty exhaust may include carbon monoxide (CO), nitrogen oxides (NOₓ), hydrocarbons (HC), oxygen (O₂), and hydrogen (H₂). After the dirty exhaust reacts with the ruthenium catalyst 503, and reduces emissions and pollutants, the clean exhaust may include carbon dioxide (CO₂), nitrogen (N₂), and water (H₂O). The exhaust then flows out of the catalytic converter 501 and into the muffler 510 or outward from the engine 10 through an exhaust tube.

In some embodiments, the catalyst 503 comprises a precious metal loading (i.e., the portion of the catalyst that includes only the precious metals) of at least 35% ruthenium by mass. The catalyst can be designed such that ruthenium constitutes a primary element of the precious metal loading. The primary element, for purposes of this application, means the element that makes up or is tied for the largest percentage of precious metal loading, by weight, within the catalyst. For example, in a catalyst 503 having 35% ruthenium and no more than 35% of any other individual element, ruthenium would be considered the primary element. Similarly, in a catalyst 503 having 50% ruthenium and 50% of another individual element, ruthenium would still be considered one of the primary elements. In some embodiments, the catalyst 503 comprises precious metal loading of between 50%-100% ruthenium by mass. A ruthenium catalyst is well suited to small air-cooled engines that are designed to operate with a rich air to fuel ratio. Ruthenium may react with gases in a lean air to fuel ratio, resulting in ruthenium loss from the catalytic converter. However, the infrequency of such ratios within small air-cooled engines allows ruthenium to remain stable during normal operation under rich conditions. Automotive engines are typically designed to operate at a stoichiometric air to fuel ratio, which requires an oxygen sensor to control the air-fuel mixing device to produce a stoichiometric air to fuel ratio. Designing the engine to operate at the stoichiometric air to fuel ratio necessarily results in situations where the engine is combusting a lean air to fuel mixture, making ruthenium unsuitable and unfavorable for use within normal automotive engines. Because ruthenium may react with excess oxygen when exposed to exhaust resulting from a lean air to fuel ratio, ruthenium is not well suited for use with catalytic converters for large automotive engines that by their nature will operate under lean fuel to air ratios with some frequency. The loss of mass of the ruthenium would mean the catalytic converter would lose effectiveness and/or need to be replaced more frequently than the other catalyst materials better suited for lean operating conditions. Accordingly, past use of ruthenium has not proven to be commercially effective.

Typical three way catalytic converters reduce emissions most efficiently when the engine is operating near the stoichiometric air-to-fuel ratio, which may not always occur within small air-cooled engines, like the engine 10. As many small engines operate below the stoichiometric air-to-fuel ratio (i.e., under rich conditions), a typical three way catalytic converter may not provide optimal emissions treatment and may prove to be a higher cost option. However, a catalytic converter with a ruthenium-based catalyst will allow a small engine to reduce exhaust emissions with minimal redesign of the engine. To use a TWC, a small engine would require an oxygen sensor and associated controller to control the air-fuel ratio to ensure stoichiometric conditions. Redesigning a small engine (e.g. the engine 10) to run at stoichiometric conditions would increase the engineering and manufacturing costs required to meet stricter emission standards, and may still prove to be less effective at treating emissions than the catalytic converters 501 described.

Referring to FIGS. 5-8, a bench test using simulated exhaust gases was performed with a typical three way catalytic converter (TWC) using an palladium, platinum, and rhodium-based catalyst and a catalytic converter including a ruthenium-based catalyst. The bench test was performed by operating an engine at simulated wide open throttle (WOT) conditions and the concentration of hydrocarbons (e.g., ethene) (HC), nitrogen oxides (NOₓ), and ammonia (NH₃) were measured at the inlet and the outlet of each catalytic converter.

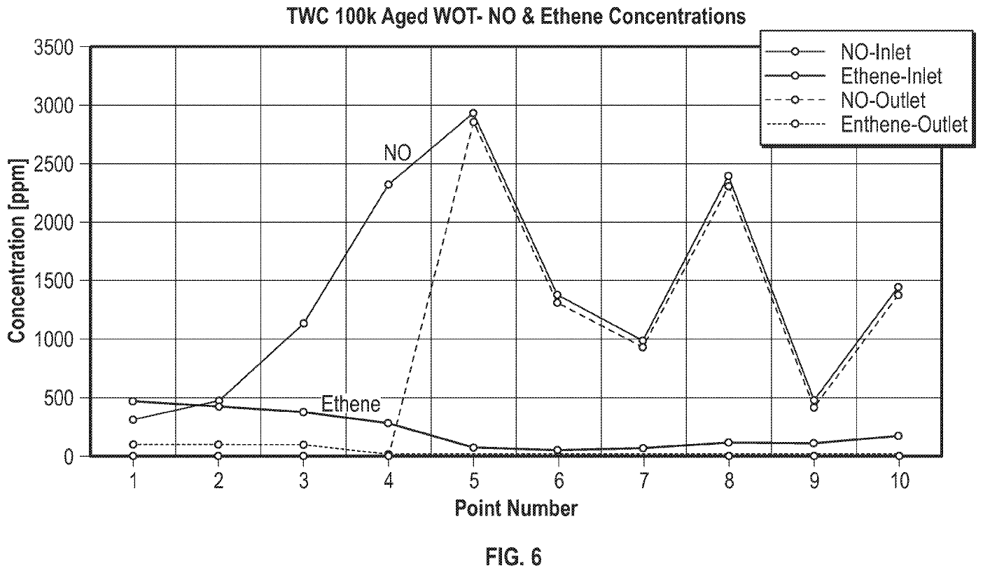

Referring to FIG. 6, an exhaust emission graph is shown measuring the concentration of nitrogen oxides (NOₓ) and hydrocarbons (e.g., ethene) (HC) at the inlet and the outlet of the typical three-way catalytic converter (TWC) at a series of measurement points. The TWC, as shown, reduces the NOₓ concentration of the exhaust by 99% and the ethene concentration of the exhaust by 90% from the inlet to the outlet.

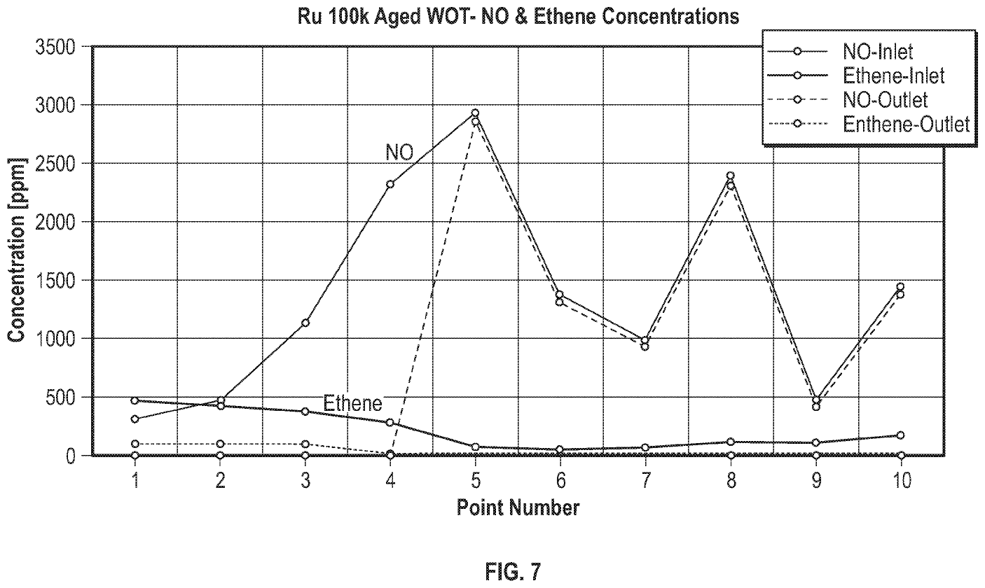

Referring to FIG. 7, an exhaust emission graph is shown measuring the concentration of nitrogen oxides (NOₓ) and hydrocarbons (e.g., ethene) (HC) at the inlet and the outlet of a ruthenium (Ru) based catalytic converter at a series of measurement points. The ruthenium-based catalytic converter reduces the NO concentration of the exhaust by 99% and the ethene concentration of the exhaust by 75% from the inlet to the outlet under the tested operational conditions.

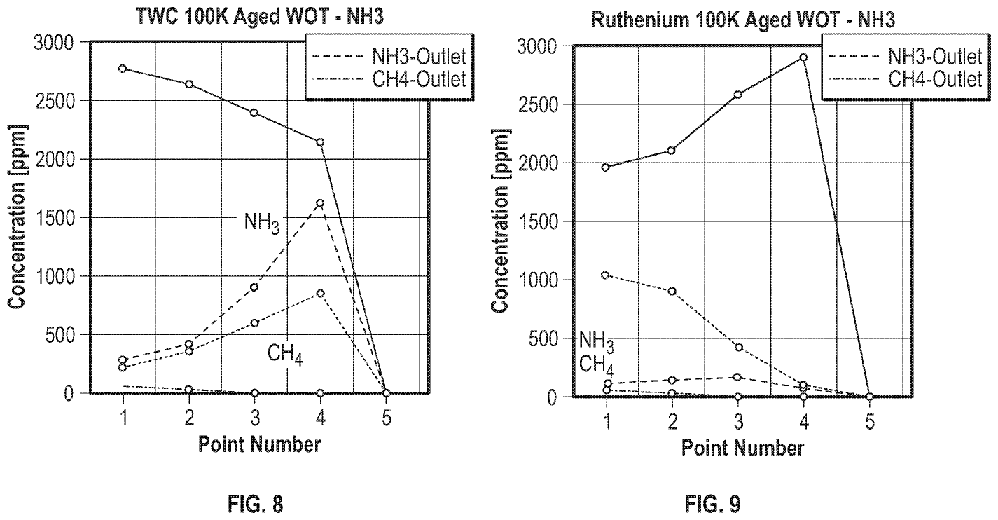

Referring to FIG. 8, an exhaust emission graph is shown measuring the concentration of ammonia (NH₃) at the outlet of a standard three-way catalytic converter (TWC) at a series of measurement points. Ammonia is a product of the reactions occurring between the fuel exhaust and the catalyst within the TWC. As shown, the TWC produces a significant concentration of ammonia that is preferably avoided.

Referring to FIG. 9, an exhaust emission graph is shown measuring the concentration of ammonia (NH₃) at the outlet of a ruthenium (Ru) based catalytic converter at a series of measurement points. As shown, the ammonia (NH₃) concentration measured at the outlet of the ruthenium (Ru) based catalytic converter is much lower than the ammonia (NH₃) concentration measured at the outlet of the TWC (shown in FIG. 8). The reaction between ruthenium and the engine exhaust produces a significantly lower concentration of ammonia. Reducing the concentration of ammonia emitted similarly reduces the unpleasant scents that are associated with ammonia and ammonia-based compounds.

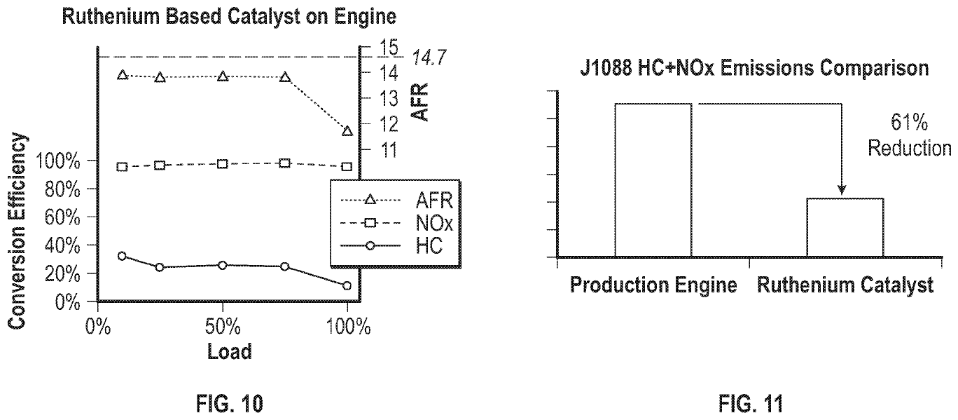

Several types of ruthenium-based catalysts 503 can be used as well to reduce emissions and significantly reduce costs from traditional catalytic converters. For example, in one embodiment, the catalyst 503 is entirely formed from ruthenium. Catalysts formed from entirely ruthenium can decrease hydrocarbon emissions by at least about twenty-five percent. In some examples, the entirely ruthenium catalyst can decrease hydrocarbon emissions by at least about thirty-five percent or more. Similarly, the entirely ruthenium catalyst can reduce NOₓ emissions by at least about fifty percent or more. In some examples, the entirely ruthenium catalyst can reduce NOₓ emissions by at least about seventy-five percent. As depicted in FIG. 10, an entirely ruthenium catalyst 503 was able to reduce NOₓ emissions by at least about ninety percent at various rich operating conditions. Similarly, the entirely ruthenium catalyst was able to reduce hydrocarbon emissions by between about twenty percent and forty percent, depending on the operating conditions. Richer operating conditions leave more unreacted gasoline, which reduces the hydrocarbon conversion efficiency. In total, and as depicted in FIG. 11, using the entirely ruthenium catalyst 503 was able to reduce overall hydrocarbon and NOₓ emissions by sixty-one percent compared to a small engine without the catalytic converter 501 described herein. While the entirely ruthenium catalyst is typically considered unsuitable for use in automobiles and other large engine systems, using an entirely ruthenium catalyst with the richer running conditions of small engines has been observed to provide significant emissions reductions while also avoiding overly hot running or exhaust conditions. Temperature stabilization of the engine, generally, could still be achieved, even with the exothermic reactions taking place within the catalytic converter.

In still other examples, other primarily-ruthenium catalysts 503 can be used. For example, in one embodiment, a catalyst 503 made of fifty percent ruthenium by weight and fifty percent platinum by weight can be used. Catalysts having this composition were also found to be effective at treating exhaust from small engines, reducing hydrocarbon and NOₓ emissions by a significant (e.g., twenty-five percent or more) amount. In another example, a catalyst 501 formed from forty percent ruthenium by weight, forty percent platinum by weight, and twenty percent iridium by weight is used. Ruthenium is still a primary element of the precious metal loading, as no other individual element has a greater percentage by weight than ruthenium. Once again, this formulation was found to reduce emissions significantly, reducing hydrocarbons by at least about twenty-five percent and reducing NOₓ emissions by at least about fifty percent.

The construction and arrangement of the apparatus, systems, and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, unless specifically stated differently some elements shown as integrally formed may be constructed from multiple parts or elements, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

1. A small air-cooled internal combustion engine comprising:
an engine block including a cylinder;
a piston within the cylinder;
a crankshaft configured to be driven by the piston;
a blower system including a fan, the fan configured to direct cooling air over the engine block;
an air-fuel mixing device for supplying an air-fuel mixture to the cylinder for combustion; and
an exhaust system for removing exhaust from the cylinder, the exhaust system comprising:
an exhaust port formed in the cylinder to allow exhaust to exit the cylinder following combustion; and
a catalytic converter fluidly coupled to the exhaust port and configured to receive exhaust from the exhaust port, the catalytic converter including a catalyst, wherein the catalyst comprises a precious metal loading having ruthenium as a primary element by mass.

2. The small air-cooled internal combustion engine of claim 1, wherein the catalyst comprises precious metal loading of at least 40% ruthenium by mass.

3. The small air-cooled internal combustion engine of claim 2, wherein the catalyst comprises precious metal loading of at least 50% ruthenium by mass.

4. The small air-cooled internal combustion engine of claim 3, wherein the catalyst comprises precious metal loading of about 50% ruthenium by mass and about 50% platinum by mass.

5. The small air-cooled internal combustion engine of claim 2, wherein the catalyst comprises precious metal loading of about 40% platinum by mass.

6. The small air-cooled internal combustion engine of claim 5, wherein the catalyst comprises precious metal loading of about 20% iridium by mass.

7. The small air-cooled internal combustion engine of claim 1, wherein the fuel system is configured to provide an air-fuel mixture to the cylinder at an air-to-fuel ratio below a stoichiometric ratio.

8. The small-air cooled internal combustion engine of claim 1, wherein the engine operates below an air to fuel ratio of 14.7 at stead-state operation.

9. The small air-cooled internal combustion engine of claim 1, wherein in operation, the engine produces a gross power output at or below 40 horsepower.

10. The small air-cooled internal combustion engine of claim 1, wherein the air-fuel mixing device comprises an electronic fuel injector for providing fuel to produce the air-fuel mixture.

11. The small air-cooled internal combustion engine of claim 1, wherein the catalytic converter is configured to reduce a concentration of nitric oxide within exhaust gas exposed to the catalyst by at least 90%.

12. (canceled)

13. The small air-cooled internal combustion engine of claim 1, wherein the engine displacement is 1000 cc or less.

14-20. (canceled)

21. A catalytic converter for a small air-cooled internal combustion engine having a displacement of one thousand cubic centimeters or less, the catalytic converter comprising:
an inlet;
a chamber fluidly coupled with the inlet, the chamber supporting a substrate having a catalyst disposed thereon, wherein the catalyst comprises a precious metal loading having ruthenium as a primary element by mass; and
an outlet fluidly coupled with the chamber and configured to direct gas outwardly away from the chamber.

22. The catalytic converter of claim 21, wherein the catalyst comprises a precious metal loading of at least 40% ruthenium by mass.

23. The catalytic converter of claim 22, wherein the catalyst comprises a precious metal loading of at least 50% ruthenium by mass.

24. The catalytic converter of claim 23, wherein the catalyst comprises a precious metal loading of about 50% ruthenium by mass and about 50% platinum by mass.

25. The catalytic converter of claim 22, wherein the catalyst comprises a precious metal loading of about 40% platinum by mass.

26. The catalytic converter of claim 25, wherein the catalyst comprises a precious metal loading of about 20% iridium by mass.

27. The catalytic converter of claim 21, wherein the catalytic converter is configured to reduce a concentration of nitric oxide in exhaust gas exposed to the catalyst by at least 90% as the exhaust gas passes from the inlet to the outlet.

28. The catalytic converter of claim 21, wherein the catalytic converter is configured to reduce a concentration of hydrocarbons in exhaust gas exposed to the catalyst by at least 20% as the exhaust gas passes from the inlet to the outlet.
